(19) United States
(12) Patent Application Publication
(10) Pub. No.: US 2023/0091709 A1
(43) Pub. Date: Mar. 23, 2023

(54) SOUND DEADENER COMPOSITION

(71) Applicant: Henkel AG & Co. KGaA, Duesseldorf (DE)

(72) Inventors: YaLong Qi, Shanghai (CN); HongYu Chu, Shanghai (CN)

(21) Appl. No.: 18/045,968

(22) Filed: Oct. 12, 2022

Related U.S. Application Data
(63) Continuation of application No. PCT/CN2020/084686, filed on Apr. 14, 2020.

(51) Int. Cl. C08L 33/02; C08K 5/3412

(52) U.S. Cl. CPC C08L 33/02; C08K 5/3412; C08L 2201/02; C08L 2201/52

(57) ABSTRACT

This invention relates to a sound deadener composition, comprising at least two carboxyl functional polymers with different glass transition temperatures (Tg); at least one organic compound with at least two aziridinyl groups per molecule; and water. The reaction between at least two carboxyl functional polymers with different glass transition temperatures (Tg) and at least one organic compound with at least two aziridinyl groups per molecule forms an IPN structure reaction product so that the cured product of the sound deadener composition according to the present invention exhibits widened temperature range for effective damping.

### TECHNICAL FIELD

This invention relates to a sound deadener composition, comprising at least two carboxyl functional polymers with different glass transition temperatures (Tg); at least one organic compound with at least two aziridinyl groups per molecule; and water. The cured product of the sound deadener composition according to the present invention exhibits widened temperature range for effective damping.

### BACKGROUND OF THE INVENTION

Damping material made from rubber is known to be used for vibration damping and noise reduction. It utilizes the viscoelastic property of rubber comprised in the composition, through the internal friction caused by the internal molecular motion of the polymer chain, to disperse the mechanical energy generated by external mechanical or sound vibration. Typically, tan δ is an indication of the effectiveness of a material's damping capabilities and is also known as loss factor. The higher the tan δ, the greater the damping coefficient. The temperature range, under which the damping material has high damping coefficient, is the effective damping temperature range.

Damping material has been widely used in the mechanical field, construction, vehicle industry, and etc. However, traditional damping material is only made of a single rubber which would have a narrow effective damping temperature range, and cannot be used in high tech domains, such as aircraft and rocket, which requires the damping material to have good damping effect at varies temperature.

Therefore, there is a need for developing a sound deadener composition, and the cured product of which has widened temperature range for effective damping.

### SUMMARY OF THE INVENTION

The present invention relates to a sound deadener composition, comprising:

(a) at least two carboxyl functional polymers with different glass transition temperatures (Tg);

(b) at least one organic compound with at least two aziridinyl groups per molecule;

wherein the aziridinyl groups of the organic compound can be the same or different from each other, and are independently represented by structure (I):

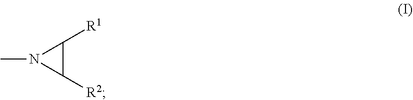

and water;
wherein
R1 and R2 are each independently a hydrogen or a C1-C20, optionally substituted, univalent hydrocarbon group; preferably a hydrogen or a C1-C10, optionally substituted, univalent hydrocarbon group; and more preferably a hydrogen or a C1-C4, optionally substituted univalent hydrocarbon group.

The present invention also relates to a cured product of the sound deadener composition.

The cured product of the sound deadener composition has widened temperature range for effective damping.

The present invention also relates to an article coated by or filled with the cured product of the sound deadener composition.

The present invention also relates to a method of preparing the sound deadener composition and a curing method therefor.

### DETAILED DESCRIPTION OF THE INVENTION

In the following passages the present invention is described in more detail. Each aspect so described may be combined with any other aspect or aspects unless clearly indicated to the contrary. In particularly, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

In the context of this disclosure, a number of terms shall be utilized.

The term “(meth)acrylate” refers to both or any one of “acrylate” and “methacrylate”. The term “(meth)acrylic” refers to both or any one of “acrylic” and “methacrylic”. The term “ethylenically unsaturated” refers to at least a site of unsaturation, which is not aromatic.

The term “hydrocarbon group” refers to an organic group consisting of carbon and hydrogen. Example of hydrocarbon group includes but limited to an alkyl group, such as methyl, ethyl, propyl, butyl, pentyl, hexyl, isopropyl, tertiary butyl, isobutyl and the groups alike; an alkenyl group, such as vinyl, allyl, butenyl, pentenyl, hexenyl and the groups alike; an aralkyl group, such as benzyl, phenethyl, 2-(2,4,6-trimethylphenyl)propyl and the groups alike; an aryl group, such as phenyl, tolyl, xyxyl and the groups alike; or an alkylidene group, such as methylidene, ethylidene, propylidene and the groups alike.

The term “optionally substituted” in the term of “optionally substituted hydrocarbon group” means that one or more hydrogens on the hydrocarbon group may be replaced with a corresponding number of substituents preferably selected from halogen, nitro, azido, amino, hydroxyl, carbonyl, ester, cyano, sulfide, sulfate, sulfoxide, sulfone, sulfone groups, and the likes.

The term “substantially free” means that a material or functional group can be present in an incidental amounts or that a particular occurrence or reaction only takes place to an insignificant extent, which does not affect desired properties. In other words, the material or functional group is not intentionally added to an indicated composition, but may be present at minor or inconsequential levels, for example, because it was carried over as an impurity as part of an intended composition component.

The term “water soluble” means that the relevant component or ingredient of the composition can be dissolved in the aqueous phase on the molecular level.

The term “water dispersible” means that that the relevant component or ingredient of the composition can be dispersed in the aqueous phase and forms a stable emulsion or suspension.

The term “glass transition temperature” refers to a temperature at which a polymer transitions between a highly elastic state and a glassy state. Glass transition temperature may be measured, for example, by dynamical mechanical analysis (DMA).

### Carboxyl Functional Polymer

The sound deadener composition of the present invention comprises at least two carboxyl functional polymers with different glass transition temperatures (Tg). The sound deadener composition may have two carboxyl functional polymers with different Tg, three carboxyl functional polymers with different Tg, or even more carboxyl functional polymers with different Tg. The carboxyl functional polymers with different glass transition temperatures (Tg) are preferably partially compatible or incompatible with each other.

The carboxyl functional polymers can be any common carboxyl functional polymer known in the art which has at least one carboxyl functional group. The carboxyl functional polymers with different glass transition temperatures preferably are water soluble or water dispersible and are derived from water soluble or water dispersible monomers and the combinations thereof, and optionally from monomers that are water insoluble. The carboxyl functional polymers with different glass transition temperatures may be obtainable by the polymerization of ethylenically unsaturated carboxylic acid monomers in the presence of initiator.

Suitable ethylenically unsaturated carboxylic acid monomer includes but is not limited to acrylic acid, glacial acrylic acid, methacrylic acid, isooctyl acrylic acid, crotonic acid, cinnamic acid, maleic acid, 2-methylmaleic acid, isocrotonic acid, fumaric acid, itaconic acid, 2-methylitaconic acid, methacrylic anhydride, isooctyl acrylic anhydride, crotonic anhydride, fumaric anhydride, maleic anhydride, and any combination thereof.

Suitable initiator may be selected from a peroxide initiator, such as acetyl peroxide, dicumyl peroxide (DCP), 2,5-dimethyl-2,5-bis(t-butylperoxy)-hexyne (DBPH), benzoyl peroxide (BPO), bis(2,4-dichlorobenzoyl)peroxide (DCBP), tert-butyl peroxypivalate (BPP), dicyclohexyl peroxydicarbonate (DCPD), potassium persulfate (KSP), ammonium persulfate (ASP), and the like; an azo-compound initiator, such as 2,2′-azo-bis(4-methoxy-2,4-dimethylvaleronitrile), 2,2′-azo-bis-isobutyronitrile, azobisisoheptonitrile, and the like; and a persulfate initiator, such as potassium persulfate, sodium persulfate, ammonium persulfate, and the like. The initiators can be used alone or in any combination.

In some embodiments of the present invention, the carboxyl functional polymers with different glass transition temperatures (Tg) preferably have at least two carboxyl functional groups per molecule.

In some embodiments of the present invention, the carboxyl functional polymers with different glass transition temperatures (Tg) are more preferably water dispersible than water soluble.

In some embodiments of the present invention, the carboxyl functional polymers with different glass transition temperatures preferably have Tg value ranging from −40 to 60° C., such as −40° C., −30° C., −20° C., −10° C., 0° C., 10° C., 20° C., 30° C., 40° C., 50° C. and 60° C.

Examples of commercially available carboxyl functional polymers are, for example, Acousticryl AV 1331, Acousticryl AV 1220 and Primal SD68 from Dow.

In some embodiments of the present invention, the amount of the carboxyl functional polymers with different glass transition temperatures (Tg) in the sound deadener composition of the invention is from 5% to 35%, and preferably from 10% to 25% by weight based on the total weight of the sound deadener composition.

Organic Compound with at least two Aziridinyl Groups

The sound deadener composition of the present invention comprises at least one organic compound with at least two aziridinyl groups per molecule. The organic compound with at least two aziridinyl groups per molecule functions to link the at least two carboxyl functional polymers with different glass transition temperatures (Tg) to form an interpenetrating polymer network (IPN structure). The mechanism of forming the IPN structure is illustrated as below:

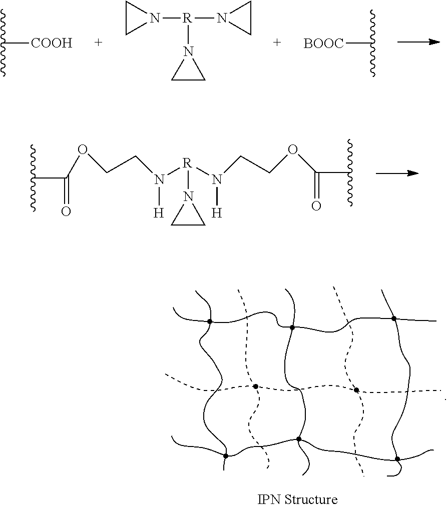

The aziridinyl groups of the organic compound of the present invention can be the same or different from each other, and are independently represented by structure (I):

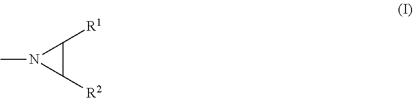

wherein
wherein R1 and R2 are each independently a hydrogen or a C1-C20, optionally substituted, univalent hydrocarbon group; preferably a hydrogen or a C1-C10, optionally substituted, univalent hydrocarbon group; and more preferably a hydrogen or a C1-C4, optionally substituted univalent hydrocarbon group.

In some embodiments of the present invention, the organic compound with at least two aziridinyl groups per molecule is preferably represented by structure (II):

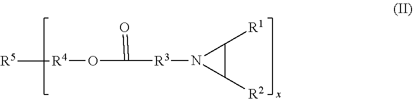

wherein
wherein R1 and R2 are each independently a hydrogen or a C1-C20, optionally substituted, univalent hydrocarbon group; preferably a hydrogen or a C1-C10, optionally substituted, univalent hydrocarbon group; and more preferably a hydrogen or a C1-C4, optionally substituted univalent hydrocarbon group.
R3 and R4 are each independently a C1 to C20 optionally substituted divalent hydrocarbon group, preferably C1 to C10 optionally substituted divalent hydrocarbon group, and more preferably C1 to C4 optionally substituted divalent hydrocarbon group;
R5 is a C1-C20 optionally substituted divalent or polyvalent hydrocarbon group, preferably a C1 to C10 optionally substituted divalent or polyvalent hydrocarbon group, and more preferably a C1 to C4 optionally substituted divalent or polyvalent hydrocarbon group; and
x is an integer from 2 to 4.

In some embodiments of the present invention, the organic compound preferably comprises at least three aziridinyl groups per molecule.

Illustrative examples of the organic compounds with at least two aziridinyl groups per molecule include but are not limited to:

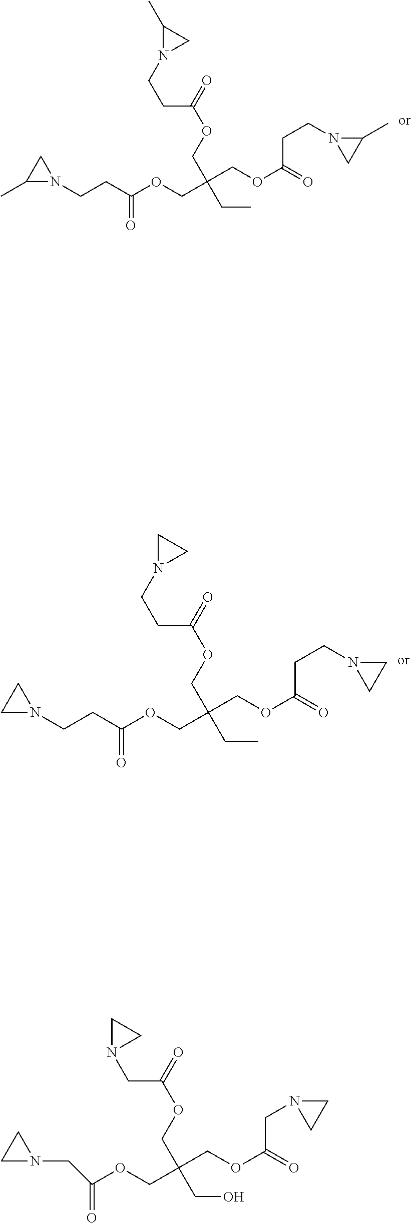

In some embodiments of the present invention, R1 and R2 in structure (I) or (II) are preferably both hydrogen when the loss factor of the cured product of the sound deadener composition to be improved is between 0 to 60° C.

In some embodiments of the present invention, at least one of R1 and R2 in structure (I) or (II) is preferably a C1-C20 optionally substituted univalent hydrocarbon group, more preferably a C1-C10 optionally substituted univalent hydrocarbon group, and even more preferably a C1-C4 optionally substituted univalent hydrocarbon group, when the loss factor of the cured product of the sound deadener composition to be improved is between −40 to 0° C.

Examples of commercially available organic compounds with at least two aziridinyl groups per molecule are, for example, XC-103, XC-105, and XC-113 from Shanghai Zealchem Co., Ltd.

In some embodiments of the present invention, the weight ratio between the at least two carboxyl functional polymers with different glass transition temperatures (Tg) and the organic compound with at least two aziridinyl groups per molecule is preferably from 100:0.5 to 100:50, more preferably from 100:1 to 100:25, and even more preferably from 100:8 to 100:12 so that the loss factor of the cured product of the sound deadener composition is better improved.

In some embodiments of the present invention, the amount of the organic compound with at least two aziridinyl groups per molecule in the sound deadener composition is from 0.1 to 5%, and preferably from 0.3 to 3% by weight based on the total weight of the sound deadener composition.

### Water

The sound deadener composition of the present invention comprises water to adjust the viscosity of the composition. The water of the present invention is preferably purified water.

In some embodiments of the present invention, the amount of water in the sound deadener composition of the invention is from 10 to 60%, such as 20%, 30%, 40% and 50%, by weight based on the total weight of the sound deadener composition.

### Additional Additives

The sound deadener composition may further comprise optional additives. The selection of suitable additives for the sound deadener composition of the invention depends on the specific intended use of the sound deadener composition and can be determined in the individual case by those skilled in the art.

### Thickening Agent

The sound deadener composition of the present invention may further comprise at least one thickening agent. Exemplary thickening agent includes but is not limited to carboxymethyl cellulose, methyl cellulose, cellulose ethers, hydroxyethyl cellulose, polyvinyl ether, polyvinyl alcohol and sodium polyphosphate. The thickening agent can be used alone or in combination. Examples of commercially available the thickening agent are, for example, Arbocel ZZ 8/1 from Rettenmaier; CMC type 75 A powder from Mikro Technik; Natrosol 250 HHR from Ashland Aqualon; and Kelzan Xanthan gum from CP Kelco.

In some embodiments of the present invention, the amount of thickening agent in the sound deadener composition is from 0 to 30%, and preferably from 0.1 to 1% by weight based on the total weight of the sound deadener composition.

### Defoamer

The sound deadener composition of the present invention may further comprise at least one defoamer. Exemplary defoamer includes but is not limited to silicone type defoamer and acrylic type defoamer. The defoamer can be used alone or in combination. Examples of commercially available defoamer are, for example, BYK-051, BYK-052, BYK-053, BYK-054, BYK-055 from BYK-Chemie GmbH; DISPARLON 1930N and DISPARLON 1934 from Kusumoto Chemicals, Ltd.; and Foamaster MO NXZ from BASF.

In some embodiments of the present invention, the amount of defoamer in the sound deadener composition is from 0 to 2%, and preferably from 0.1 to 1% by weight based on the total weight of the sound deadener composition.

### Corrosion Inhibitor

The sound deadener composition of the present invention may further comprise at least one corrosion inhibitor. Exemplary corrosion inhibitor includes but is not limited to cyclohexylamine, diammonium phosphate, dilithium oxalate, dipotassium oxalates, dipotassium phosphates, phosphoric acid, nickel phosphate, and magnesium phosphate. The corrosion inhibitor can be used alone or in combination. Examples of commercially available corrosion inhibitor are, for example, PCG 1201, PCG1909, and PCG 2390 from Polygon Chemie AG.

In some embodiments of the present invention, the amount of corrosion inhibitor in the sound deadener composition is from 0 to 10%, and preferably from 0.1 to 5% by weight based on the total weight of the sound deadener composition.

### Flame Retardant

The sound deadener composition of the present invention may further comprise at least one flame retardant. Exemplary flame retardant includes but is not limited to a phosphorus-based plasticizer, aluminum hydroxide, magnesium hydroxide, and a thermally expandable graphite. The flame retardant can be used alone or in combination. Examples of commercially available corrosion inhibitor are, for example, aluminum hydroxide from Shanghai Jianghu Industry Co., Ltd.; ADT 20, ADT 150, and ADT 802 from Shijiazhuang ADT Carbonic Material Factory; and CX150, CX 200, and CX 325 from Qingdao Tianheda Graphite Co., Ltd.

In some embodiments of the present invention, the amount of flame retardant in the sound deadener composition is from 0 to 40%, and preferably from 15 to 30% by weight based on the total weight of the sound deadener composition.

### pH Adjusting Agent

The sound deadener composition of the present invention may further comprise at least one pH adjusting agent. Exemplary pH adjusting agent includes but is not limited to citric anhydride, alkali metal hydroxides, and buffered organic acid solutions (e.g. acetic acid, glutamic acid, and citric acid). The pH adjusting agent can be used alone or in combination. Examples of commercially available pH adjusting agent are, for example, tetrapotassium pyrophosphate from Redox Chemicals Pty. Ltd.; and ammonia water from Showa Denko.

In some embodiments of the present invention, the amount of pH adjusting agent in the sound deadener composition is from 0 to 5%, and preferably from 0.1 to 2% by weight based on the total weight of the sound deadener composition.

### Filler

The sound deadener composition of the present invention may further comprise at least one filler. Exemplary filler includes but is not limited to a reinforcing filler, such as fumed silica, precipitated silica, crystalline silica, molten silica, dolomite, and carbon black; a fibrous filler, such as asbestos, glass fiber and filament; and other fillers, such as ground calcium carbonate, colloidal calcium carbonate, magnesium carbonate, barium carbonate, barium sulfate, diatomaceous earth, baked clay, clay, talc, baryte, anhydrous gypsum, titanium oxide, bentonite, organic bentonite, ferric oxide, aluminum fine powder, flint powder, zinc oxide, active zinc flower, mica, zinc flower, white lead. The filler can be used alone or in combination. Examples of commercially available filler are, for example, Glass fiber 4.5 mm from Saint-Gobain; Muskovit Mica 247 from Ziegler & Co. GmbH; calcium carbonate from Fengxian Bazi Shifen; and AEROSIL R 974 available from Evonik Specialty Chemicals (Shanghai) Co, Ltd.

In some embodiments of the present invention, the amount of filler in the sound deadener composition is from 0 to 40%, and preferably from 5 to 25% by weight based on the total weight of the sound deadener composition.

Other optional additives that may be used in the sound deadener composition of the present invention, include but are not limited to antioxidants; biocides; dyes; pigments; and the mixtures thereof.

In a preferred embodiment, the sound deadener composition comprises:
(a) from 5 to 35% by weight of at least two carboxyl functional polymers with different glass transition temperatures (Tg);
(b) from 0.1 to 5% by weight of at least one organic compound with at least two aziridinyl groups per molecule;
(c) from 10 to 60% by weight of water;
(d) from 0 to 30% by weight of at least one thickening agent;
(e) from 0 to 2% by weight of at least one defoamer;
(f) from 0 to 10% by weight of at least one filler;
(g) from 0 to 40% by weight of at least one flame retardant;
(h) from 0 to 10% by weight of at least one corrosion inhibitor; and
(i) from 0 to 5% by weight of at least one pH adjusting agent;
   wherein the weight percentages of all components add up to 100% by weight.

The sound deadener composition of the present invention may be prepared by mixing at least two carboxyl functional polymers with different glass transition temperatures (Tg) and at least one organic compound with at least two aziridinyl groups per molecule, together with the optional additives, such as at least one thickening agent, at least one pH adjusting agent, at least one filler, at least one flame retardant, at least one corrosion inhibitor, and at least one defoamer, in water homogeneously.

In some embodiments of the present invention, the sound deadener composition is preferably prepared by the steps of:
1) mixing at least two carboxyl functional polymers with different glass transition temperatures (Tg) with at least one thickening agent and/or at least one pH adjusting agent in water to obtain a gel;
2) adding at least one filler, and/or at least one flame retardant, and/or at least one corrosion inhibitor, and/or at least one defoamer to the gel and mixing well all of the components to get a pre-mixer; and
3) adding at least one organic compound with at least two aziridinyl groups per molecule to the pre-mixer and mixing well all of the components under vacuum.

The sound deadener composition of the present invention may be applied to a substrate surface via a scarper, a sprayer or an extruder, and allowed to be cured at room temperature.

In some embodiments, the curing of the sound deadener composition may comprise steps of:
1) exposing the sound deadener composition to room condition for 1-4 hours;
2) heating the sound deadener composition for 2-6 hours at a temperature range from 40 to 80° C.; and
3) cooling the sound deadener composition and allowing the sound deadener to cure for 5 to 10 days at room temperature.

A loss factor of the cured product of the sound deadener composition in the present invention may be measured according to GB/T 16406.

The cured product of the sound deadener composition of the present invention has a loss factor improved when it is measured at a temperature between the Tg values of carboxyl functional polymers. The cured product of the sound deadener composition preferably has an improved ratio of loss factor no less than 10%, and more preferably has an improved ratio of loss factor no less than 20%, and even more preferably has an improved ratio of loss factor no less than 40% compared with a benchmark loss factor which is measured for a cured product of a sound deadener composition containing the same carboxyl functional polymers, but without the organic compound with at least two aziridinyl groups per molecule in the composition.

### EXAMPLES

The present invention will be further described and illustrated in detail with reference to the following examples. The examples are intended to assist one skilled in the art to better understand and practice the present invention, however, are not intended to restrict the scope of the present invention. All numbers in the examples are based on weight unless otherwise stated.

### Example 1-8

The following materials were used in the examples.
water;
Tetrapotassium pyrophosphate (from Redox Chemicals Pty. Ltd.);
Arbocel ZZ 8/1 (natural cellulose fiber, from Rettenmaier);
Glass fiber (4.5 mm in length, from Saint Gobain Vetrotex);
Acousticryl AV 1331 (acrylic emulsion with a Tg value of 16° C., containing 50% by weight of acrylic polymer and 50% by weight of water, from Dow);
Acousticryl AV 1220 (acrylic emulsion with a Tg value of 0° C., containing 50% by weight of acrylic polymer and 50% by weight of water, from Dow);
Primal SD68 (acrylic emulsion with a Tg value of −20° C., containing 50% by weight of acrylic polymer and 50% by weight of water, from Dow);
XC-103 (trimethylolpropane tris(3-aziridinylpropanoate), from Shanghai Zealchem Co., Ltd.);
XC-113 (trimethylolpropane tris(2-methyl-1-aziridinepropionate), from Shanghai Zealchem Co., Ltd.);
Foamaster MO NXZ (defoamer from BASF);
CMC type 75 A powder (carboxymethylcellulose sodium salt, from Mikro Technik);
Natrosol 250 HHR (hydroxyethylcellulose, from Ashland Aqualon);
Muskovit Mica 247 (mica, from Ziegler & Co. GmbH);
Muskovit Mica N800 (mica, from Ziegler & Co. GmbH);
Aluminum hydroxide (from Shanghai Jianghu Industry);
Calcium carbonate (from Fengxian Bazi Shifen);
PCG 1201 (corrosion inhibitor from Polygon Chemie); and
Kelzan Xanthan gum (from CP Kelco).

The sound deadener compositions were prepared as Examples (Ex.).

### Example 1

Acousticryl AV 1331 (15 g), Acousticryl AV 1220 (8 g), Primal SD68 (15 g), Arbocel ZZ 8/1 (0.6 g), CMC type 75 A powder (0.1 g), Natrosol 250 HHR (0.1 g), Kelzan Xanthan gum (0.1 g), tetrapotassium pyrophosphate (0.3 g) were mixed together in water (4.6 g) at a speed of 1750 r/min for 30 minutes by a mixer (EUROATAR 60 digital from IKA) to get a gel.

Glass fiber (0.8 g), Foamaster MO NXZ (0.1 g), Muskovit Mica 247 (27 g), calcium carbonate (10 g), aluminum hydroxide (15 g), and PCG 1201 (0.3 g) were added to the gel, and mixed at a speed of 1000 r/min for 30 seconds by a speed mixer (SpeedMixer DAC 600.2 VAC-P from Flack Tek Inc.) to get a pre-mixer;

The pre-mixer was further blended at a speed of 2000 r/min for 60 seconds by a speed mixer (SpeedMixer DAC 600.2 VAC-P from Flack Tek Inc.) under vacuum to get a sound deadener composition of Ex.1.

A loss factor L1 (benchmark loss factor) of the cured sound deadener composition of Ex.1 was measured according to GB/T 16406. B&K equipment was used to test the loss factor, and cantilever beam method was applied. The test specimen was prepared by applying the sound deadener composition of Ex.1 on the surface of a cold rolled steel (200 mm long, 10 mm wide and 1 mm thick).

The sound deadener composition was cured by the steps of:
1) allowing the sound deadener composition to be left on the cold rolled steel at room temperature for 2 hours.
2) heating the sound deadener composition for 4 hours at 60° C.; and
3) cooling the sound deadener composition and allowing the sound deadener composition to cure for 7 days at room temperature.

The dimension of cured sound deadener composition on the cold rolled steel was 2 mm in thickness with 180 mm free length.

An improved ratio of loss factor M1 was calculated in the following way:

M1=(L1−L1)/L1.

### Example 2

Acousticryl AV 1331 (15 g), Acousticryl AV 1220 (8 g), Primal SD68 (15 g), Arbocel ZZ 8/1 (0.6 g), CMC type 75 A powder (0.1 g), Natrosol 250 HHR (0.1 g), Kelzan Xanthan gum (0.1 g), tetrapotassium pyrophosphate (0.3 g) were mixed together in water (4.1 g) at a speed of 1750 r/min for 30 minutes by a mixer (EUROATAR 60 digital from IKA) to get a gel.

Glass fiber (0.8 g), Foamaster MO NXZ (0.1 g), Muskovit Mica 247 (27 g), calcium carbonate (10 g), aluminum hydroxide (15 g), and PCG 1201 (0.3 g) were added to the gel, and mixed at a speed of 1000 r/min for 30 seconds by a speed mixer (SpeedMixer DAC 600.2 VAC-P from Flack Tek Inc.) to get a pre-mixer.

XC-103 (0.5 g) was further added to the pre-mixer and mixed at a speed of 2000 r/min for 60 seconds by a speed mixer (SpeedMixer DAC 600.2 VAC-P from Flack Tek Inc.) under vacuum to get a sound deadener composition of Ex.2.

The sound deadener composition of Ex.2 was allowed to cure in the same way as in Ex.1. A loss factor L2 of the cured sound deadener composition of Ex.2 was measured in the same way as in Ex.1. An improved ratio of loss factor M2 was calculated in the following way:

M2=(L2−L1)/L1.

### Example 3

A sound deadener composition of Ex.3 was prepared in a similar way as for Ex.2, except that 3.6 g of water was used to make the gel, and 1 g of XC-103 was added to the gel to form the pre-mixer.

The sound deadener composition of Ex.3 was allowed to be cured in the same way as in Ex.1. A loss factor L3 of the cured sound deadener composition of Ex.3 was measured in the same way as in Ex.1. An improved ratio of loss factor M3 was calculated in the following way:

M3=(L3−L1)/L1.

### Example 4

A sound deadener composition of Ex.4 was prepared in a similar way as for Ex.2, except that 2.6 g of water was used to make the gel, and 2 g of XC-103 was added to the gel to form the pre-mixer.

The sound deadener composition of Ex.4 was allowed to be cured in the same way as in Ex.1. A loss factor L4 of the cured sound deadener composition of Ex.4 was measured in the same way as in Ex.1. An improved ratio of loss factor M4 was calculated in the following way:

M4=(L4−L1)/L1.

### Example 5

A sound deadener composition of Ex.5 was prepared in a similar way as for Ex.2, except that 1.6 g of water was used to make the gel, and 3 g of XC-103 was added to the gel to form the pre-mixer.

The sound deadener composition of Ex.5 was allowed to be cured in the same way as in Ex.1. A loss factor L5 of the cured sound deadener composition of Ex.5 was measured in the same way as in Ex.1.

An improved ratio of loss factor M5 was calculated in the following way:

M5=(L5−L1)/L1.

### Example 6

Acousticryl AV 1331 (15 g), Acousticryl AV 1220 (8 g), Primal SD68 (15 g), Arbocel ZZ 8/1 (0.6 g), CMC type 75 A powder (0.1 g), Natrosol 250 HHR (0.1 g), Kelzan Xanthan gum (0.1 g), tetrapotassium pyrophosphate (0.3 g) were mixed together in water (4.6 g) at a speed of 1750 r/min for 30 minutes by a mixer (EUROATAR 60 digital from IKA) to get a gel.

Glass fiber (0.8 g), Foamaster MO NXZ (0.1 g), Muskovit Mica N800 (27 g), calcium carbonate (10 g), aluminum hydroxide (15 g), and PCG 1201 (0.3 g) were added to the gel, and mixed at a speed of 1000 r/min for 30 seconds by a speed mixer (SpeedMixer DAC 600.2 VAC-P from Flack Tek Inc.) to get a pre-mixer.

The pre-mixer was further blended at a speed of 2000 r/min for 60 seconds by a speed mixer (SpeedMixer DAC 600.2 VAC-P from Flack Tek Inc.) under vacuum to get a sound deadener composition of Ex.6.

The sound deadener composition of Ex.6 was allowed to be cured in the same way as in Ex.1. A loss factor L6 (benchmark loss factor) of the cured sound deadener composition of Ex.6 was measured in the same way as in Ex.1. An improved ratio of loss factor M6 was calculated in the following way:

M6=(L6−L6)/L6.

### Example 7

Acousticryl AV 1331 (15 g), Acousticryl AV 1220 (8 g), Primal SD68 (15 g), Arbocel ZZ 8/1 (0.6 g), CMC type 75 A powder (0.1 g), Natrosol 250 HHR (0.1 g), Kelzan Xanthan gum (0.1 g), tetrapotassium pyrophosphate (0.3 g) were mixed together in water (2.6 g) at a speed of 1750 r/min for 30 minutes by a mixer (EUROATAR 60 digital from IKA) to get a gel.

Glass fiber (0.8 g), Foamaster MO NXZ (0.1 g), Muskovit Mica N800 (27 g), calcium carbonate (10 g), aluminum hydroxide (15 g), and PCG 1201 (0.3 g) were added to the gel, and mixed at a speed of 1000 r/min for 30 seconds by a speed mixer (SpeedMixer DAC 600.2 VAC-P from Flack Tek Inc.) to get a pre-mixer.

XC-113 (2 g) was further added to the pre-mixer and mixed at a speed of 2000 r/min for 60 seconds by a speed mixer (SpeedMixer DAC 600.2 VAC-P from Flack Tek Inc.) under vacuum to get a sound deadener composition of Ex.7.

The sound deadener composition of Ex.7 was allowed to be cured in the same way as in Ex.1. A loss factor L7 of the cured sound deadener composition of Ex.7 was measured in the same way as in Ex.1. An improved ratio of loss factor M7 was calculated in the following way:

M7=(L7−L6)/L6.

### Example 8

A sound deadener composition of Ex.8 was prepared in a similar way as for Ex.7, except that 0.6 g of water was used to make the gel, and 4 g of XC-113 was added to the gel to form the pre-mixer.

The sound deadener composition of Ex.8 was allowed to be cured in the same way as in Ex.1. A loss factor L8 of the cured sound deadener composition of Ex.8 was measured in the same way as in Ex.1. An improved ratio of loss factor M8 was calculated in the following way:

M8=(L8−L6)/L6.

The test results of Example 1 to 8 are shown in Table 1. The sound deadener composition incorporating either XC-103 (Example 2-5) or XC-113 (Example 7-8) had a better loss factor than the sound deadener composition in Example 1 or Example 6. When the loss factor to be improved for the cured sound deadener composition is at 10° C., the sound deadener composition incorporating XC-103 was more preferred. When the loss factor to be improved for the cured sound deadener composition is at −10° C., the sound deadener composition incorporating XC-113 was more preferred.

TABLE 1
Test results

| | Ex. | Ex. | Ex. | Ex. | Ex. | Ex. | Ex. | Ex. |
|---|---|---|---|---|---|---|---|---|
| | 1 | 2 | 3 | 4 | 5 | 6 | 7 | 8 |
| Loss factor | 0.065 | 0.079 | 0.078 | 0.087 | 0.08 | 0.092 | 0.1 | 0.106 |
| (L) at | | | | | | | | |
| 10° C. | | | | | | | | |
| Improved | 0 | 22% | 20% | 34% | 23% | 0 | 9% | 15% |
| ratio of | | | | | | | | |
| loss factor | | | | | | | | |
| (M) at | | | | | | | | |
| 10° C. | | | | | | | | |
| Loss factor | 0.046 | 0.048 | 0.049 | 0.052 | 0.047 | 0.053 | 0.08 | 0.077 |
| (L) at | | | | | | | | |
| −10° C. | | | | | | | | |
| Improved | 0 | 4% | 7% | 13% | 2% | 0 | 51% | 45% |
| ratio of | | | | | | | | |
| loss factor | | | | | | | | |
| (M) at | | | | | | | | |
| −10° C. | | | | | | | | |

What is claimed is:

1. A sound deadener composition comprising components:
(a) at least two carboxyl functional polymers with different glass transition temperatures (Tg);
(b) at least one organic compound with at least two aziridinyl groups per molecule, wherein the aziridinyl groups can be the same or different from each other, and are independently represented by structure (I): 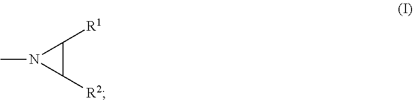
and
(c) water;
wherein
R1 and R2 are each independently a hydrogen or a C1-C20, optionally substituted, univalent hydrocarbon group.

2. The sound deadener composition according to claim 1, wherein the at least two carboxyl functional polymers with different glass transition temperatures are selected such that each has Tg value in a range of from −40 to 60° C.

3. The sound deadener composition according to claim 1, wherein in component (a) the at least two carboxyl functional polymers with different glass transition temperatures are partially compatible or incompatible with each other; and in component (b) R1 and R2 are each independently a hydrogen or a C1-C10, optionally substituted, univalent hydrocarbon group.

4. The sound deadener composition according to claim 1, wherein the at least two carboxyl functional polymers with different glass transition temperatures are water dispersible and/or water soluble.

5. The sound deadener composition according to claim 1, wherein the at least one organic compound comprises at least three aziridinyl groups per molecule.

6. The sound deadener composition according to claim 1, wherein R1 and R2 are each independently a hydrogen or a C1-C10, optionally substituted, univalent hydrocarbon group; and the at least two carboxyl functional polymers with different glass transition temperatures (Tg) and the organic compound with at least two aziridinyl groups per molecule are present in a weight ratio of from 100:1 to 100:25.

7. The sound deadener composition according to claim 1, wherein the organic compound with at least two aziridinyl groups per molecule is represented by structure (II): 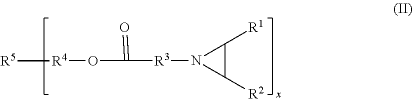
wherein
R1 and R2 are each independently a hydrogen or a C1-C20, optionally substituted, univalent hydrocarbon group;
R3 and R4 are each independently a C1 to C20, optionally substituted, divalent hydrocarbon group;
R5 is a C1-C20, optionally substituted, divalent or polyvalent hydrocarbon group; and
x is an integer from 2 to 4.

8. The sound deadener composition according to claim 7, wherein R1 and R2 in structure (I) or (II) are both hydrogen when the loss factor of the cured product of the sound deadener composition to be improved is between 0 to 60° C.

9. The sound deadener composition according to claim 7, wherein at least one of R1 and R2 in structure (I) or (II) is a C1-C20 optionally substituted univalent hydrocarbon group, when the loss factor of the cured product of the sound deadener composition to be improved is between −40 to 0° C.

10. The sound deadener composition according to claim 7, wherein at least one of R1 and R2 in structure (I) or (II) is a C1-C4 optionally substituted univalent hydrocarbon group, when the loss factor of the cured product of the sound deadener composition to be improved is between −40 to 0° C., and the at least two carboxyl functional polymers with different glass transition temperatures (Tg) and the organic compound with at least two aziridinyl groups per molecule are present in a weight ratio of from 100:8 to 100:12.

11. The sound deadener composition according to claim 1, wherein the at least two carboxyl functional polymers with different glass transition temperatures (Tg) and the organic compound with at least two aziridinyl groups per molecule are present in a weight ratio of from 100:0.5 to 100:50.

12. The sound deadener composition according to claim 1, further comprising at least one thickening agent, and/or at least one defoamer, and/or at least one filler, and/or at least one corrosion inhibitor, and/or at least one pH adjusting agent, and/or at least one flame retardant.

13. The sound deadener composition according to claim 1, comprising:
(a) from 5 to 35% by weight of the at least two carboxyl functional polymers with different glass transition temperatures (Tg);
(b) from 0.1 to 5% by weight of the at least one organic compound with at least two aziridinyl groups per molecule;
(c) from 10 to 60% by weight of water;
(d) from 0 to 30% by weight of at least one thickening agent;
(e) from 0 to 2% by weight of at least one defoamer;
(f) from 0 to 10% by weight of at least one filler;
(g) from 0 to 40% by weight of at least one flame retardant;
(h) from 0 to 10% by weight of at least one corrosion inhibitor; and
(i) from 0 to 5% by weight of at least one pH adjusting agent;
wherein the weight percentages of all components add up to 100% by weight.

14. A cured product of the sound deadener composition according to claim 1.

15. An article coated by or filled with the cured product of the sound deadener composition according to claim 1.

16. A method of preparing the sound deadener composition according to claim 1, comprising steps of mixing the at least two carboxyl functional polymers with different glass transition temperatures (Tg) and the at least one organic compound with at least two aziridinyl groups per molecule, together with optional additives, if present, in water thereby generating a homogeneous mixture.

17. The method of claim 16, wherein one or more of the optional additives comprising at least one thickening agent, at least one pH adjusting agent, at least one filler, at least one flame retardant, at least one corrosion inhibitor, at least one defoamer or combinations thereof are included in the homogenous mixture.

18. A curing method for the sound deadener composition according to claim 1, comprising steps of:
1) exposing the sound deadener composition to room temperature for 1 to 4 hours;
2) heating the sound deadener composition for 2 to 6 hours at 40 to 80° C.; and
3) cooling the sound deadener composition and allowing the sound deadener composition to cure for 5 to 10 days.
